(19) United States
(12) Patent Application Publication
(10) Pub. No.: US 2024/0123682 A1
(43) Pub. Date: Apr. 18, 2024

(54) DEVICE FOR ADDITIVE MANUFACTURING

(71) Applicant: SOMIC VERPACKUNGSMASCHINEN GMBH & CO. KG, Amerang (DE)

(72) Inventor: Christoph Kögel, Prutting (DE)

(21) Appl. No.: 18/484,556

(22) Filed: Oct. 11, 2023

(30) Foreign Application Priority Data
Oct. 13, 2022 (EP) 22201264.3

(51) Int. Cl. B29C 64/245; B29C 64/232; B29C 64/295; B29C 64/393; B33Y 30/00; B33Y 50/02

(52) U.S. Cl. CPC B29C 64/245; B29C 64/232; B29C 64/295; B29C 64/393; B33Y 30/00; B33Y 50/02; B29C 64/118

(57) ABSTRACT

The invention relates to a device for additive manufacturing of a component not belonging to the device. The device includes a print bed unit formed in magnetic levitation technology and including a stator assembly and at least one mover. Further, the device includes a print head unit configured to apply a material intended to form the component onto a printing surface. According to the invention, the printing surface is formed on a surface of the at least one mover facing towards the print head unit.

### CROSS REFERENCE TO RELATED APPLICATION

This application claims priority to European Patent Application No. 22 201 264.3, filed in Europe on Oct. 13, 2022, the entire contents of which are hereby incorporated herein by this reference.

### TECHNICAL FIELD

The invention relates to a device for the additive manufacturing of a component not belonging to the device, comprising a print bed unit designed in magnetic levitation technology with a stator assembly and at least one mover, the stator assembly having a movement surface relative to which the at least one mover is movable, and a print head unit which is set up to apply a material intended for forming the component to a print surface.

### BACKGROUND

Such a device for additive manufacturing is known from the generic US 2020/0030995 A1. In this device, several movers are connected to each other via a complex connecting body on which the printing surface is formed. The connecting body has a complex construction with which the movers are connected and the relative movement between the movers is restricted or compensated. The device known from US 2020/0030995 A1 for additive manufacturing of a component is therefore cost-intensive, and the synchronized control of multiple movers is costly and complex. Due to its height, the structure may bend, resulting in greater inaccuracies in the positioning of the printing surface and/or the component to be manufactured than in other known devices.

From EP 3 290 187 A1, another device for additive manufacturing of a component is known, which comprises a superconductor that is fixedly coupled to a magnetic field generator via a magnetic field that is frozen in the horizontal direction due to the superconductor. Separate means are provided for movement in the horizontal direction, which move the magnetic field generator and thus the superconductor and the printing surface. Thus, this device is complex and costly and has a high weight.

### SUMMARY

It is the problem of the present invention to provide a device for additive manufacturing with a simplified structure.

This problem is solved by a generic device in which the printing surface is formed on a surface of the at least one mover facing towards the print head unit.

By forming the printing surface directly on a surface of the at least one mover, the device has a simplified structure. Furthermore, the production costs of the device can be reduced. Since only the at least one mover and the print head unit have to be controlled, the control effort can also be reduced. The at least one mover and thus also the printing surface can be positioned very precisely and flexibly on the movement surface and thus relative to the print head unit. Accordingly, there is also no need for time-consuming adjustment of the printing surface to a zero point of the device. This means that throughput times and handling times can be reduced.

At this point, it should be noted that the mover can move on the movement surface both in the horizontal direction and in the vertical direction. The horizontal direction refers to any direction parallel to the movement surface, such as the transverse direction and the longitudinal direction. The vertical direction extends orthogonally to the movement surface and thus to the horizontal direction. The vertical direction may also be referred to as the height direction.

It is understood that the at least one mover is movable during the manufacturing process as well as before and after it. In the following, the term manufacturing process refers to the process in which material is applied to the printing surface in order to additively manufacture a component. Since building up a component in layers is characteristic of additive manufacturing, the term “applying to a printing surface” includes not only the application of a first material layer directly to the printing surface, but also the application of further material layers to one or more material layer(s) already deposited on the printing surface. Similarly, the device can be used to apply material to a component that is already on the printing surface prior to the start of the manufacturing process in order to produce a predetermined shape. In this case, too, the print head unit applies material to a printing surface in order to manufacture a component, namely to a semi-finished product located on the printing surface. This can be advantageous, for example, for repairs or to continue an interrupted manufacturing process.

Furthermore, it should be noted that the device can also build a plurality of components on one and the same printing surface.

In a further aspect of the invention, it is proposed that the at least one mover can be movable relative to the movement surface both in the horizontal direction and in the vertical direction. The possible range of motion in the vertical direction of currently known magnetic levitation technology systems is limited. Nevertheless, the resulting limited dimensions are sufficient for certain components that are more planar in shape. In addition, systems are under development that allow a greater range of motion in the height direction of the at least one mover. By using such systems, a component with a greater vertical extent can be formed.

In principle, it is conceivable for the print head unit to be completely rigid. In the event that a larger printing area in the vertical direction is required, it is proposed that the print head unit be movable in the vertical direction relative to the movement surface. Thus, the vertical printing area and thus the vertical extension of the component to be manufactured can be increased to the sum of the maximum vertical movement dimension of the print head unit and the maximum vertical movement dimension of the at least one mover.

Since the movement of the at least one mover in the horizontal direction is not subject to any restriction, the design can be further simplified if the print head unit is movable only in the vertical direction relative to the movement surface. Thus, the walls of the component to be manufactured are created by moving the at least one mover relative to the print head unit while material is being applied to the printing surface.

In conventional devices for additive manufacturing, it is necessary to adjust the device after each printing operation. During the adjustment process, the print head unit is moved horizontally over the printing surface and the distance between the printing surface and the print head unit is adjusted vertically so that the distance between the printing surface and the print head unit is the same over the entire printing surface. In order to eliminate this time-consuming adjustment process, a control unit can be provided which is set up to control both the movement of the at least one mover in the horizontal direction and the movement of the print head unit in the vertical direction, in addition to the movement of the at least one mover in the horizontal direction. In other words, a control unit can be provided that is set up to control both the vertical movement of the at least one mover and the vertical movement of the print head unit in addition to the horizontal movement of the at least one mover. In this way, the control unit can easily ensure that the distance between the printing surface on the mover and the print head unit is always the same. Any unevenness of the printing surface can also be compensated for by the common control unit for the mover and print head unit.

Prior art print head units with mechanical height adjustment by means of a spindle drive have a large vertical printing area, but only a low accuracy of the height adjustment. For example, in practice, a height adjustment with a resolution in the vertical direction of 10 to 20 μm is used, whereby a gradation of the adjustability of 50 μm is realistically used. In contrast, the accuracy of magnetic height adjustment of the at least one mover on the movement surface using magnetic levitation technology is significantly better, namely, for example, on the order of 2 μm.

At this point, it should be noted that the at least one mover has a plurality of permanent magnets, preferably four permanent magnets at the corners and a fifth permanent magnet in the center. In contrast, the stator assembly has electromagnets via which the stator assembly generates a magnetic field to control the position and, if necessary, the movement of the at least one mover in the horizontal and vertical directions. The vertical movement of the at least one mover is controlled by the strength of the magnetic field of the stator arrangement.

Since the control unit is set up to control both the vertical movement of the at least one mover and the vertical movement of the print head unit, the limitations of the magnetic adjustment of the at least one mover with respect to the height range can be compensated by the large vertical adjustment range of the mechanically adjustable print head unit. At the same time, the low accuracy of the mechanics of the height adjustment of the print head unit can be compensated by the high accuracy of the magnetic levitation technology, especially in vertical direction.

By setting up the control unit to control the movement of the at least one mover in the horizontal and vertical directions and the vertical movement of the print head unit, the movements of the at least one mover and the print head unit can be coordinated, preferably synchronized, with one another. This means that it is no longer necessary to adjust the print head unit after each printing process and/or each change of printing surface. Instead, a plurality of printing processes are possible without intermediate adjustment of the print head unit. The adjustment of the print head unit can be reduced to predetermined time intervals.

Furthermore, the control unit can be set up to control the movement of the print head unit in the horizontal direction, provided that the print head unit can be moved in the horizontal direction.

In conventional devices for additive manufacturing of a component, the printing surface is arranged on a printing plate that has to be changed manually after printing. This change is associated with long downtimes and high handling costs. Particularly in the case of series production of components, the device can therefore not be utilized to a satisfactory extent. For easier and faster changing of the printing surface and to reduce downtimes, a plurality of movers can be provided.

During the manufacturing process, the print head unit builds up a component on the printing surface of a first mover. The first mover is located in a printing area on the movement surface during the manufacturing process. When the manufacturing process is completed, or when the manufacturing process is stopped, the first mover moves out of the printing area, and moves, for example, to a delivery position, which can also be located on the movement surface. The component on the first mover can be removed from the first mover after the mover has moved out of the printing area and fed to a further process step, for example a rework step or a packaging step.

While the first mover is moving out of the printing area, another mover, preferably with a component-free printing surface, can move into the printing area. Once the further mover is in the printing area, the print head unit can produce a component on the printing surface of the further mover.

The movement of the first mover out of the printing area and the movement of the further mover into the printing area can be coordinated, preferably synchronously. Consequently, the manual effort of changing the printing surface is eliminated and any number of components can be produced automatically one after the other.

It should also be noted at this point that movers with different dimensions and/or movers with printing surfaces made of different materials can be provided without changing the printing surface leading to long downtimes. This reduces non-value-adding time and increases the throughput rate.

Large components extending over two or more movers can also be produced without problems. For this purpose, a rigid printing plate can be provided that extends over a plurality of movers.

To manufacture the component, the material is usually heated and then applied to the printing surface by the print head unit. In order to achieve a higher component quality, it is proposed that the at least one mover comprises a heating unit intended for heating the printing surface. This heats the at least one mover and thus also the printing surface. If the heated material now reaches the likewise heated printing surface, too rapid cooling or even thermal shock of the material will be prevented.

In a further development of the invention, it is proposed that the heating unit comprises a coil and a heating resistor connected in series with the coil. The stator assembly may be suitable for generating, in addition to a magnetic field for moving and/or positioning the at least one mover, a time-varying magnetic field component for heating the printing surface (additional magnetic field). The additional magnetic field generated by the stator assembly induces a power in the coil, which in turn is dissipated in a known manner at the heating resistor connected in series with the coil in the form of thermal energy. For this purpose, the coil is made of conductive material, for example copper. This design of the heating unit means that no separate power supply is required for heating the printing surface.

In principle, both the magnetic field for the movement and/or positioning of the at least one mover and the additional magnetic field for the heating of the printing surface can be generated simultaneously by the stator assembly and controlled by the control unit. However, in order that the movement of the at least one mover is not influenced by the additional magnetic field for heating the printing surface, the control unit may be arranged to take into account the influence of the additional magnetic field on the movement and/or positioning of the at least one mover when generating the two magnetic fields. For example, the control unit may select the frequency ranges for driving the movement and/or positioning of the at least one mover and for driving the heating of the printing surface such that the movement and/or position of the at least one mover is not influenced by the additional magnetic field for heating the printing surface. Further, the control unit may be adapted to vary the magnetic field of the stator assembly such that a predefined temperature is set on the printing surface and the at least one mover moves to or is held in a predefined position.

The device may further comprise a temperature sensor for adjusting the temperature to a target value. The temperature sensor may be connected to a temperature control unit via an electronic line. Alternatively, the temperature sensor and the temperature control unit can also be connected to each other via a radio connection. According to a further alternative, the temperature sensor can be designed as an infrared camera. Advantageously, the control unit comprises the temperature control unit.

For high component quality in particular, it is important that the component manufacturing process is carried out in a room with as few cold zones as possible. To avoid costly air conditioning of the entire area in which the device is set up, for example a production hall, a print space housing can be provided which encloses the print head unit and the at least one mover. This simplifies temperature control, especially precise temperature control. At the same time, energy requirements can be kept low because the volume of the print space housing is smaller than the volume of the entire area in which the device is set up. A temperature-regulated print space housing also makes it possible to increase the material spectrum for additive manufacturing of the component.

In view of the fact that the main focus of the invention is the setup of the device and the movement of the print head unit, it should be added at this point that standard printing processes, in particular filament extrusion processes or jetting processes, can be used to manufacture the component. Thus, all conventional extrudable or sprayable materials, for example plastics, in particular thermoplastic plastics, can be used for the production of the component.

### BRIEF DESCRIPTION OF THE DRAWINGS

The invention will be explained in more detail below by means of an embodiment with reference to the accompanying drawings.

FIG. 1 shows a perspective view of a device according to the invention, and

FIG. 2 shows a cross-sectional view through the device of FIG. 1 along line I-I.

### DETAILED DESCRIPTION

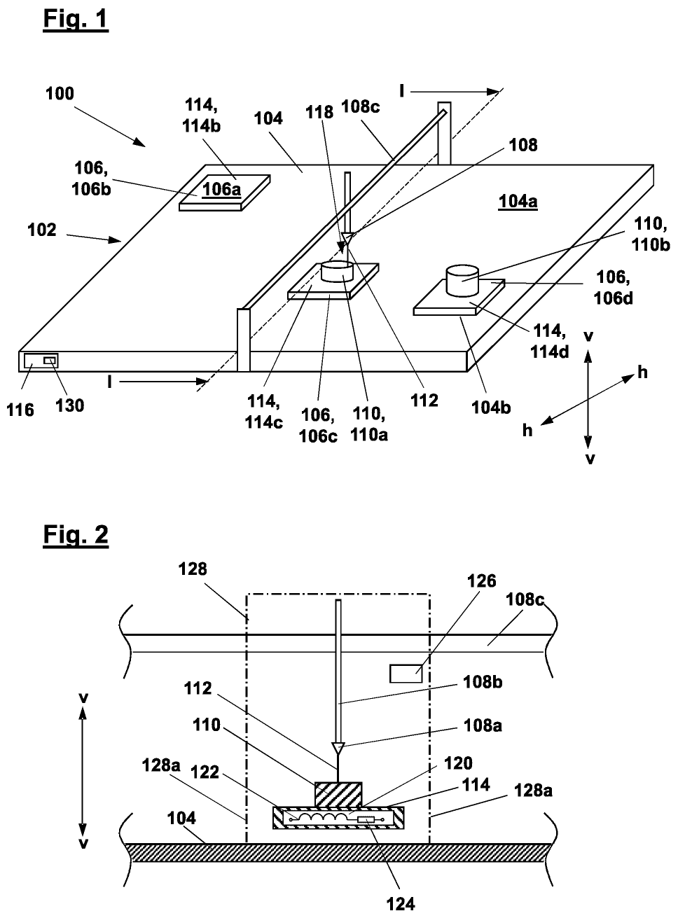

In FIG. 1, a device for additive manufacturing of a component is generally designated 100. The device 100 comprises a print bed unit 102 designed in magnetic levitation technology with a stator assembly 104 and at least one mover 106 (here three movers 106). The stator assembly 104 includes a movement surface 104a relative to which the movers 106 are movable.

Each of the movers 106 can move parallel to the movement surface 104a in the horizontal-zonal direction h, as well as orthogonal to the movement surface 104a in the vertical direction v.

Further, the device 100 comprises a print head unit 108 (indicated only in a rough schematic) adapted to apply a material 112 intended to form a component 110 onto a printing surface 114. The printing surface 114 is formed on a surface 106a of the mover 106 facing towards the print head unit 108, as exemplified in FIG. 1 for one of the movers 106.

Although the device according to the invention can also be used to apply material to a component or semi-finished product that is already on the printing surface 114 prior to the start of the additive manufacturing process, the operation of the device 100 will be explained below using the example of manufacturing a component on a printing surface 114 that is free of components at the start of the manufacturing process for ease of understanding.

In order to apply material 112 to the printing surface 114 and to manufacture a component 110, the print head unit 108 comprises a print head 108a (see FIG. 2). The material 112 is heated in the print head unit 108 before being applied to the printing surface 114 and/or the component 110. The heated material 112, for example thermoplastic material, is applied to the print surface 114 by the print head 108a. After a first layer of material 112 has been applied to the printing surface 114, the print head unit 108 moves in a vertical direction v away from the printing surface 114. For this purpose, the print head unit 108 is movable in the vertical direction v relative to the movement surface 104a. According to the exemplary embodiment described, the print head unit 108 is only movable in the vertical direction v relative to the movement surface 104a. Alternatively or additionally, the at least one mover 106, on whose surface the component 110 is manufactured, can move in the vertical direction v away from the print head unit 108 and towards the movement surface 104a. The at least one mover 106 and/or the print head unit 108 may repeatedly move toward and away from each other in the vertical direction during the manufacturing process.

For coordinated movement of the at least one mover 106 and the print head unit 108, a control unit 116 is further provided, which is shown only schematically in FIG. 1. The control unit 116 is set up to control both the movement of the mover 106 in the horizontal direction h and the movement of the mover 106 in the vertical direction v and the movement of the print head unit 108 in the vertical direction v. The movement of the print head unit 108 is controlled by the control unit 116. By moving the mover 106 in the horizontal direction h, a layer of the component 110 can be built up in a plane parallel to the movement surface 104a. By the movements of the print head unit 108 in the horizontal direction h and of the mover 106 also in the horizontal direction h, which are controlled by the control unit 116, the extension of the component 110 to be produced in the height direction h is determined.

As shown in FIG. 2, the movement of the print head unit 108, in particular of the print head 108a, in the embodiment shown is effected via a mechanical height adjustment unit 108b, for example a spindle mechanism, which is attached to a bridge 108c. The bridge 108c may extend a distance across the movement surface 104a.

As mentioned above, the device 100 may include a plurality of movers 106. In FIG. 1, three movers 106 are shown. A first mover 106b includes a blank printing surface 114b. A second mover 106c is shown in a state in which a first component 110a is being manufactured by depositing material 112 on the printing surface 114c as part of a manufacturing process. The second mover 106c is located in the printing area 118, namely the area in which a mover 106 is located on its printing surface 114 during the manufacturing of the component by the print head unit 108. During the manufacturing operation, the print head unit 108 builds a first component 110a on the printing surface 114c of the mover 106c, which is located in the printing area 118, according to the procedure described above.

Once the manufacturing process of a first component 110a is completed, the second mover 106c moves out of the printing area 118. It may move on the movement surface 104a to a removal position 104b, for example the position where a third mover 106d is located in FIG. 1, carrying a completed component 110b on its printing surface 114d. In this position, the finished component 110b can be removed from the mover 106d and fed to a downstream process step.

While the second mover 106c leaves the printing area 118 carrying a finished component 110b, the first mover 106b can move into the printing area 118. As exemplified in FIG. 1, the printing surface 114b of the first mover 106b does not yet have a component, so it is component-free.

The change of a mover 106b with a manufactured component 110 out of the printing area 118 and a movement of a first mover 106b with an empty printing surface 114b into the printing area 118 can not only be fully automated, but also performed simultaneously.

FIG. 2 shows a sectional view through the device 100 according to the invention in horizontal direction h. This sectional direction is indicated by the arrows marked I in FIG. 1.

To prevent the material 112 heated by the print head unit 108 from suffering thermal shock during application to the printing surface 114, the mover 106 has a heating unit 120 intended for heating the printing surface 114. This heating unit 120 includes a coil 122 and a heating resistor 124 connected in series with the coil 122. Due to a magnetic field (not shown) generated by the stator assembly 104, the coil 122 generates electrical power which in turn dissipates as heat energy from the heating resistor 124. Thus, the surface 106a of the mover 106 facing towards the print head unit 108 is heated, and thus the printing surface 114 is also heated.

The control unit 116 is adapted to control the magnetic field generated by the stator assembly 104, which is equally suitable for controlling the movement and/or positioning of the mover 106 and the heat generated by the heating unit 120.

For improved temperature control, the device 100 further comprises a temperature sensor 126, such as an infrared camera. The temperature sensor 126 is connected by means of a radio connection to a temperature control unit 130, which is configured to set a target temperature for the printing range 118. The temperature control unit 130 may be included in the control unit 116.

To reduce the area to be climatized, the device 100 further comprises a print space housing 128 (shown as a dash-dotted line in FIG. 2). The print space housing 128 encloses the print head unit 108 and the mover 106, which is located in the printing area 118. Further, the temperature sensor 126 is disposed within the print space housing 128. A target temperature can be set in the print space housing 128. Hereby, the range of materials for the structure of the component 110 can be increased.

In order to avoid heat loss and at the same time not to hinder the automatic change of movers 106 out of or into the printing area 118, opening and closing openings can be provided on two opposite sides 128a of the print space housing 128. Preferably, the openings 128a are in a closed state during the fabrication process so that temperature regulation can be targeted during fabrication.

Although not shown, a plurality of movers 106 may have a continuous printing surface 114 so that components with larger horizontal dimensions can be manufactured.

1. Device for additive manufacturing of a component not belonging to the device, comprising:
a print bed unit formed in magnetic levitation technology and comprising a stator assembly and at least one mover, the stator assembly having a movement surface relative to which the at least one mover is movable; and
a print head unit adapted to apply a material intended to form the component onto a print surface,
wherein the printing surface is formed on a surface of the at least one mover facing toward the print head unit.

2. Device according to claim 1,
wherein the at least one mover is movable relative to the movement surface both in a horizontal direction and in a vertical direction.

3. Device according to claim 1,
wherein the print head unit is movable in a vertical direction relative to the movement surface.

4. Device according to claim 1,
wherein the print head unit is movable only in a vertical direction relative to the movement surface.

5. Device according to claim 2,
wherein a control unit is provided, which is arranged to control both the movement of the at least one mover in the vertical direction and the movement of the print head unit in the vertical direction, in addition to the movement of the at least one mover in the horizontal direction.

6. Device according to claim 1,
wherein a plurality of movers is provided.

7. Device according to claim 1,
wherein the at least one mover comprises a heating unit intended for heating the printing surface.

8. Device according to claim 7,
wherein the heating unit comprises a coil and a heating resistor connected in series with the coil.

9. Device according to claim 1,
wherein the device further comprises a temperature sensor.

10. Device according to claim 1,
wherein a print space housing is provided that encloses the print head unit and the at least one mover.
